(19) United States
(12) Patent Application Publication
(10) Pub. No.: US 2011/0022237 A1
(43) Pub. Date: Jan. 27, 2011

(54) DISPENSING DRY LUBRICATION SYSTEM FOR A CONVEYER

(75) Inventor: Scott Bennett, Stillwater, MN (US)

Correspondence Address: IPLM GROUP, P.A., POST OFFICE BOX 18455, MINNEAPOLIS, MN, 55418, US

(73) Assignee: Ecolab Inc.

(21) Appl. No.: 12/509,862

(22) Filed: Jul. 27, 2009

(51) Int. Cl. G05D 7/06; F16N 21/00; F16N 15/00

(52) U.S. Cl. 700/283; 184/36

(57) ABSTRACT

A dry lubrication system for a conveyer is provided. The dry lubrication system includes a pump and at least one dispensing head. The pump is used to pump dry lube. The at least one dispensing head is coupled to receive dry lube from the pump. The at least one dispensing head is configured to deliver a flow of dry lube on a conveyer at a rate that is greater than 3 milliliters per second (mls) without the dispensing head touching the conveyer. In some embodiments the dispensing head is one of at least one duckbill valve and at least one of a micro tube.

### BACKGROUND

Conveyer systems in commercial packing or packing operations require lubrication to ensure products travel on the conveyer systems as desired. Typically two types of lubrications are used. The first type is a concentrated lubricant that is diluted with water to form an aqueous lubricant solution. Although this type of lubrication system permits high-speed operation of conveyer systems, it requires a large amount of water. The large amount of water can cause an unduly wet environment which may not be desirable in a given operation. The second type of lubrication is called a dry lube. Dry lubes historically have referred to a lubricant composition with less than 50% water that is applied less frequently without dilution. Hence, large amounts of water are not needed to apply the lubricant. However, without the relatively low viscosity provided by the added water, applying the dry lube can be an issue.

One method of applying dry lube is with the use of energized nozzles. With energized nozzles lubricant is broken into a spray of fine droplets by the energy which is supplied for example by compressed air. A typical delivery rate of lubricant using this method is 1-2 milliliters per second (mls). Another method involves non-energized nozzles. In this embodiment, the dry lube is simply pumped through the nozzle without air assistance. A typical delivery rate of lubricant using this method is also about 1-2 mls. Yet another method used to deliver dry lube is with the use of brushes. In this method, dry lube is dispensed into the brushes that are in contact with a surface of its associated conveyer. The brushes spread the dry lubricate over the surface of the conveyer. A typical delivery rate of the dry lube in this manner is about 3-10 mls. One issue with the use of brushes is that they collect debris such as dirt, food, soil and bacteria. Another issue with brushes is that they need to be replaced on a regular basis due to deformity or wear that occurs during use.

For the reasons stated above and for other reasons stated below which will become apparent to those skilled in the art upon reading and understanding the present specification, there is a need in the art for a method of delivering dry lube to a conveyer system requiring relatively large delivery amounts in a effective and efficient manner.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a dry lubrication system for a conveyer is provided. The dry lubrication system includes a pump and at least one dispensing head. The pump is used to pump dry lube. The at least one dispensing head is coupled to receive dry lube from the pump. The at least one dispensing head is configured to deliver a flow of dry lube on a conveyer at a rate that is greater than 3 milliliters per second (mls) without the dispensing head touching the conveyer.

### BRIEF DESCRIPTION OF THE DRAWINGS

The present invention can be more easily understood and further advantages and uses thereof more readily apparent, when considered in view of the detailed description and the following figures in which:

FIG. 1 is an illustration of a dry lubrication system implementing duckbill valves of one embodiment of the present invention;

FIGS. 2A is a bottom view of a closed duckbill valve used in the dry lubrication system of FIG. 1;

FIG. 2B is a bottom view of an open duckbill valve used in the dry lubrication system of FIG. 1; and

FIG. 3 is an illustration of another dry lubrication system implementing micro tubes of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a method of delivering relatively large quantities of dry lube over a relatively short period of time onto a conveyer system without physically contacting the conveyer system with the delivery mechanism. In one embodiment, the delivery system includes the use of one or more duckbill valves that dispense droplets of dry lube on the conveyer system. In another embodiment, one or more micro tubes are used to dispense droplets.

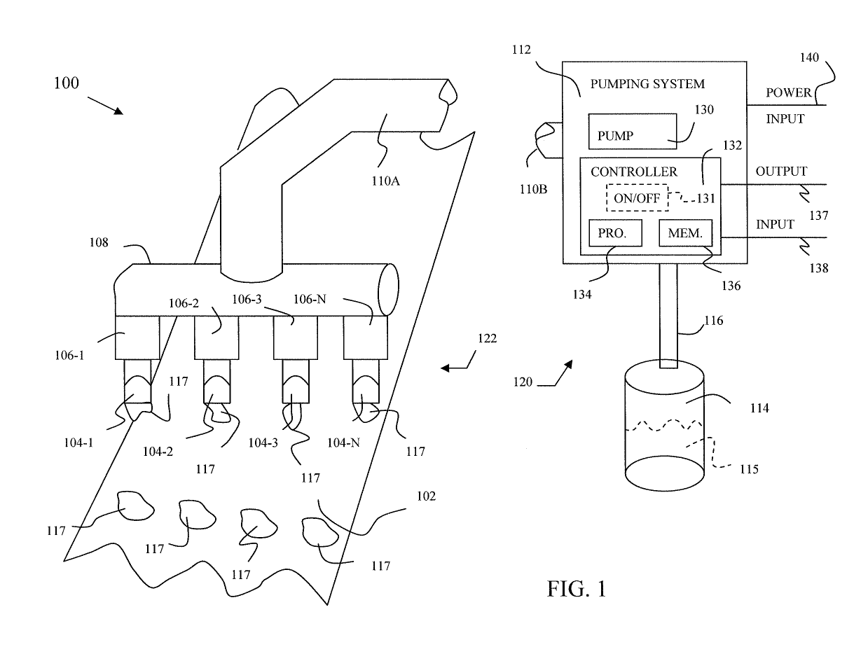

Referring to FIG. 1, a dry lubrication system 100 of one embodiment of the present invention is illustrated. The lubrication system 100 includes a delivery assembly 120 and a dispensing assembly 122. The delivery assembly 120 includes a pumping system 112, a pick up tube 116 and a container 114 of dry lube 115. The pumping system 112 further includes a pump 130 and a controller 132 that controls the function of the pump 130. The pump 130 in one embodiment is a pneumatic pump. Other types of pumps can be used and therefore the present invention is not limited to just pneumatic pumps. The controller 132 in one embodiment includes one or more on/off timers 131 that control the frequency and the duration of the flow of dry lube 115 pumped by the pump 130. The controller 132 in another embodiment 132 includes at least one processor 134 that implements instructions that control the frequency and the duration of the flow of the dry lube 115 pumped by the pump 130. Also included in the controller 132 in this embodiment is a memory 136 to store instructions. A user input 138 to the controller 132 provides an input of instructions so that the frequency and duration of the flow of dry lube 115 via the pump 130 can be adjusted.

A processor in general, such as processor 134, includes or functions with software programs, firmware or computer readable instructions for carrying out various methods, process tasks, calculations, and control functions. These instructions are typically tangibly embodied on any appropriate medium, such as memory 136, used for storage of computer readable instructions or data structures. Such computer readable media can be any available media that can be accessed by a general purpose or special purpose computer or processor, or any programmable logic device. Suitable computer readable media may include storage or memory media such as magnetic or optical media, e.g., disk or CD-ROM, volatile or non-volatile media such as RAM (e.g. SDRAM, DDR SDRAM, RDRAM, SRAM, etc.), ROM, EEPROM, flash memory, etc.

In one embodiment, an output 137 is used to provide an indication to a user via display the current configuration of the system (e.g. the current frequency and duration of pump activation). Further, as illustrated in FIG. 1, a power source 140 is provided to the pumping system 112. The power source 140 provides power to at least the pump 130 and the controller 134. In use, the controller 132, based on the instructions, operates the 130 pump based on a given frequency for a given duration. The pump 130 when activated retrieves dry lube 115 via the pickup tube 116 in the drum 114 and pumps the dry lube 115 out through pump output tubing 110B. As stated above, the pump 130 is activated at a given frequency and for a given duration by control of the controller 132.

Pump output tubing 110B is coupled to dispense receiving tubing 110A of the dispensing assembly 122. The dispense receiving tubing 110A is further coupled to a manifold 108 in the embodiment of FIG. 1. Coupled to the manifold 108 is a plurality of connection tubes 106-1 through 106-N. Coupled to the connections tubes 106-1 through 106-N in turn are duckbill valves 104-1 through 104-N. In particular, each connection tube 106-1 through 106-N includes a duckbill valve 104-1 through 104-N. Although FIG. 1 illustrates the use of plurality of duckbill valves 104-1 through 104-N, one or more duckbill valves 104-1 through 104-N connected to one or more connection tubes 106-1 through 106-N can be used depending on the application. The duckbill valves 104-1 through 104-N dispense droplets 117 (beads) of dry lube 115 on the conveyer 102.

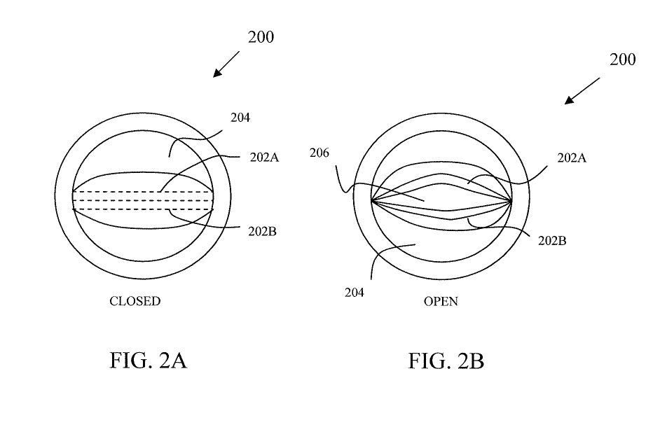

Illustrations on how a duckbill valve 200 of one embodiment works is illustrated in FIGS. 2A and 2B. In particular, FIG. 2A illustrates a bottom view of the duckbill valve 200 in a closed configuration and FIG. 2B illustrates a bottom view of the duckbill valve 200 in an open configuration. The duckbill valve 200 includes an elastic portion 204 that in some embodiments is generally shaped like a beak of a duck. The elastic portion 204 of the duckbill valve 200 deforms in shape in response to pressure differences to form an opening. The pressure, in embodiments, is provided by the pumping of dry lube by the pump. In FIG. 2A, the duckbill valve 200 without a select pressure is illustrated. Without the select pressure lips 202A and 202B of the elastic portion 204 remain closed. In this position no dry lube 115 is dispensed onto the conveyer 102. Once the pressure builds up to the select amount, the dry lube 115 deflects the lips 202A and 202B and allows a bead of dry lube 117 to pass through an opening 206 to the conveyer 102. Once the bead of dry lube 117 passes through, the lips 202A and 202B of the elastic portion 204 close since the pressure at this point is less than the select pressure needed to open the lips 202A and 202B. Hence, in this embodiment, select beads of dry lube 117 are provided by the duckbill valves 104-1 through 104-N. The amount of dry lube 115 in a bead (or droplet) of dry lube 117 is dependant on the variables of the pressure provided by the pump, the duration of time the pump is activated and the stiffness of the elastic portion 204 in the duckbill valve 200. Hence, the desired amount of dispensed dry lube 117 over a period of time can be achieved by adjusting one or more of the variables.

One advantage of the use of a duckbill valve 200 is that it can provide a larger quantity of dry lube 115 in a relatively short period of time to a conveyer system which may be desirable in a given application. For example, as stated above, a typical nozzle distribution rate of dry lube 115 is 1 to 2 milliliters per second (mls) and a typical distribution rate of the dry lube with use of brushes is 3 to 10 mls. With a duckbill valve system, distributions over 10 mls per valve are possible. Moreover, unlike the brush application that touches the conveyer 102, the duckbill valve system (not being contact with the conveyer 102) does not collect debris. Hence, embodiments can provide over 3 mls rate without touching the conveyer 102. In embodiments, products on the conveyer and movement of the conveyer, etc. assist in spreading the dry lube 115 delivered by the duckbill valve 200. Hence, the use of duckbill valves 200 in an unconventional way (conventionally they are used to prevent backflow in a system) provides a system that delivers a larger quantity of dry lube 115 in a relatively short period of time.

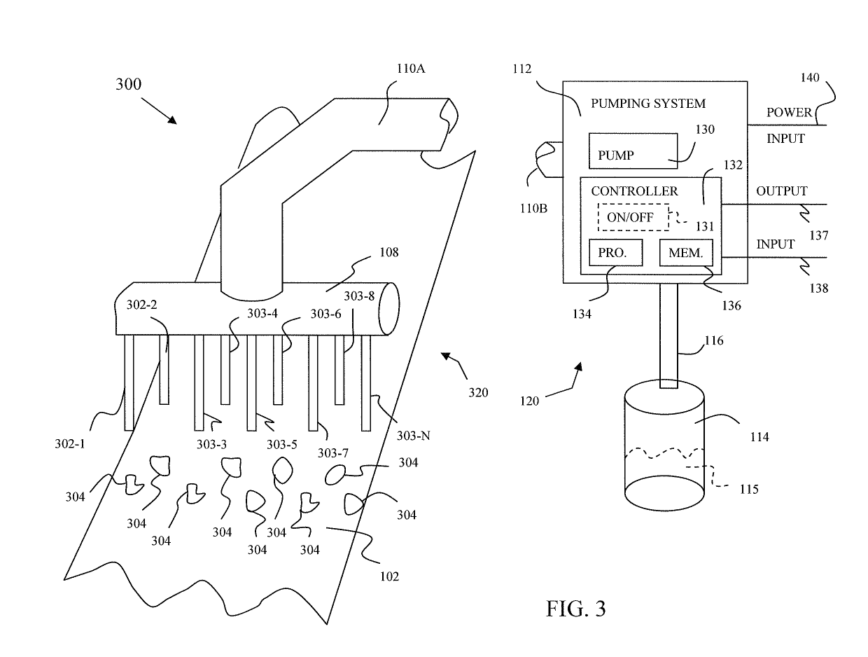

Another embodiment of a dry lubrication system 300 is illustrated in FIG. 3. In the embodiment of FIG. 3, micro tubing 302-1 through 302-N (typically used in the medical industry) is used instead of duckbill valves. Micro tubing can be formed from polymers, metals, glass and elastomers. As illustrated, micro tubing 302-1 through 302-N are coupled to receive dry lube 115 in the manifold 108. Hence, the micro tubing 302-1 through 303-N are mounted above the conveyer 102 and provide passages for the dry lube 115 to pass in dripping beads (droplets) of dry lube 304 on the conveyer 102. Here again, since the micro tubes 302-1 through 302-N do not touch the conveyer 102, they do not collect debris. Also, like the duckbill valve embodiment, a larger quantity of dry lube 115 can be distributed over a short period of time. In one embodiment more than 3 mls is possible without touching the conveyer 102. The amount of distribution is dependant on variables such as the diameter passage size of the micro tubing, the pressure on the dry lube 115 and the duration of the pump activation. Hence, the dispensing of a select amount of dry lube can be achieved by adjusting one or more of the variables. In FIG. 3, the micro tubing 302-1 through 302-N are illustrated as extending from the manifold in rows having a staggered formation. The micro tubing 302-1 through 302-N could also be in a straight line as the duckbill valves 104-1 through 104-N of FIG. 1 are illustrated. Moreover, some applications may only require a single micro tube. Hence, various configurations of one or more dispensing heads (micro tubes 302 or duckbill valves 104) are contemplated in embodiments.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A dry lubrication system comprising:
a pump to pump dry lube; and
at least one dispensing head coupled to receive dry lube from the pump, the at least one dispensing head configured to deliver a quantity of dry lube on a conveyer at a rate that is greater than 3 milliliters per second (mls) without the dispensing head touching the conveyer.

2. The lubrication system of claim 1, wherein the at least one dispensing head is a duckbill valve.

3. The lubrication system of claim 1, wherein the at least one dispensing head is a micro tube.

4. The lubrication system of claim 1, further comprising:
a manifold coupled to receive the dry lube from the pump, the at least one dispensing head coupled to the manifold to receive the dry lube.

5. The lubrication system of claim 1, further comprising:
a controller configured to control the activation of the pump.

6. The lubrication system of claim 5, wherein the controller further comprising:
a processor to carry out control instructions relating to activation of the pump;
an input to receive the control instructions; and
a memory to store the control instructions.

7. The lubrication system of claim 5, wherein the controller further comprises:
at least one on/off timers to control the activation of the pump.

8. The lubrication system of claim 1, further comprising:
a pickup tube in fluid communication with the pump to pick up the dry lube from a container.

9. A lubrication system for a conveyer comprising:
at least one duckbill valve coupled to receive dry lube from a dry lube delivery system, the at least one duckbill valve dispensing the dry lube on the conveyer.

10. The lubrication system of claim 9, further comprising:
at least one manifold coupled to receive the dry lube from the pump, the at least one duckbill valve in fluid communication with the at least one manifold.

11. The lubrication system of claim 10, further comprising:
at least one connection tube, the at least one connection tube connecting the at least one duckbill valve to the at least one manifold.

12. The lubrication system of claim 9, wherein the at least one duckbill valve includes:
an elastic portion having an opening that is normally closed, the normally closed opening configured to open in response to a select amount of pressure provided by the dry lube.

13. The lubrication system of claim 9, the dry lube delivery system further comprising:
a pump to pump dry lube; and
a controller configured to control the activation of the pump.

14. The lubrication system of claim 13, further comprising:
a pick up tube in fluid communication with the pump to pick up dry lube.

15. The lubrication system of claim 13, wherein the controller further comprises:
a processor to carry out instructions relating the activation of the pump;
an input to receive the instructions; and
a memory to store the instructions.

16. The lubrication system of claim 13, wherein the controller further comprises:
at least one timer to control the activation of the pump.

17. The lubrication system of claim 9, wherein the at least one duckbill valve is configured to deliver more than 3 mls of dry lube per an activation period of the delivery system.

18. A lubrication system for a conveyer comprising:
at least one micro tube coupled to receive dry lube from a dry lube delivery system, the at least one micro tube dispensing the dry lube on the conveyer.

19. The lubrication system of claim 18, further comprising:
at least one manifold coupled to receive the dry lube from the pump, the at least one micro tube in fluid communication with the at least one manifold.

20. The lubrication system of claim 18, the dry lube delivery system further comprising:
a pump to pump dry lube; and
a controller configured to control the activation of the pump.

21. The lubrication system of claim 20, wherein the controller further comprises:
a processor to carry out instructions relating the activation of the pump;
an input to receive the instructions; and
a memory to store the instructions.

22. The lubrication system of claim 20, wherein the at least one micro tube delivers more than 3 mls of dry lube per an activation period of the deliver system.

23. The lubrication system of claim 20, wherein the controller further comprises:
at least one timer to control the activation of the pump.
